(19) United States
(12) Patent Application Publication
(10) Pub. No.: US 2009/0271221 A1
(43) Pub. Date: Oct. 29, 2009

(54) Method and Apparatus for Providing Medical Records Registration

(76) Inventors: Rabih Aridi, Los Angeles, CA (US); William Naim, Los Angeles, CA (US)

Correspondence Address: James M. Wu;JW Law Group, 84 W. Santa Clara Street, Suite 820, San Jose, CA, 95113, US

(21) Appl. No.: 12/428,759

(22) Filed: Apr. 23, 2009

Related U.S. Application Data
(60) Provisional application No. 61/047,170, filed on Apr. 23, 2008.
(60) Provisional application No. 61/047,176, filed on Apr. 23, 2008.
(60) Provisional application No. 61/047,180, filed on Apr. 23, 2008.
(60) Provisional application No. 61/047,183, filed on Apr. 23, 2008.

(51) Int. Cl. G06Q 50/00; H04L 9/32

(52) U.S. Cl. 705/3; 705/2; 726/5

(57) ABSTRACT

A method and network for managing and transferring medical information are disclosed. A network, in one embodiment, includes a portable medical device and a medical records registration (“MRR”) system for handling and transferring medical information. The portable medical device includes patient or client verification information and it is capable of issuing a request for medical related information via a communications network. The MRR system is capable of authenticating the request in response to a set of predefined verifications and obtaining the medical related information after passage of the authentication. The medical related information is subsequently forwarded in accordance with the request.

### CROSS-REFERENCE TO RELATED APPLICATIONS

This application claims the priority of earlier filed US provisional applications as following:
a. U.S. provisional patent application No. 61/047,170, filed on Apr. 23, 2008, which is herein incorporated by reference;
b. U.S. provisional application Ser. No. 61/047,176, filed on Apr. 23, 2008, which is herein incorporated by reference;
c. U.S. provisional application Ser. No. 61/047,180, filed on Apr. 23, 2008, which is herein incorporated by reference; and
d. U.S. provisional application Ser. No. 61/047,183, filed on Apr. 23, 2008, which is herein incorporated by reference.

### FIELD

The exemplary embodiment(s) of the present invention relates methods and systems of data communications. More specifically, the exemplary embodiment(s) of the present invention relates to data communications in medical records.

### BACKGROUND

As high-speed communications networks, computer-based systems, portable devices, mobile smart phones appliances, and the like become more prevalent, instant communications and information availability can be achieved and implemented. With the availability of wireless communications network, a mobile user can obtain or download information via digital images from a remote server via the Internet or World Wild Web connections. Various application programs have been developed to facilitate and process the massive information across the Internet.

A problem associated with the current digital-age environment is that the accessing of personal medical records is generally not available. It typically takes time and/or effort to transport personal or patient's medical records since medical data or information is usually scattered across multiple places, such as doctors' offices, hospitals, and/or insurance companies. Extracting and/or retrieving medical related information for a particular patient from doctor's offices, hospitals, and/or insurance companies is never easy partially due to the privacy and security concerns.

### SUMMARY OF THE INVENTION

A method and network for managing and transferring medical information are disclosed. A network, in one embodiment, includes a portable medical device and a medical records registration (“MRR”) system for handling and transferring medical information. The portable medical device includes patient or client verification information and it is capable of issuing a request for medical related information via a communications network. The MRR system is capable of authenticating the request in response to a set of predefined verifications and obtaining the medical related information after passage of the authentication. The medical related information is subsequently forwarded in accordance with the request.

Additional features and benefits of the present invention will become apparent from the detailed description, figures and claims set forth below.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating a network having a medical records registration system in accordance with one embodiment of the present invention;

FIG. 2 is a block diagram illustrating a medical records registration system in accordance with one embodiment of the present invention;

FIG. 3 is a flowchart illustrating a process of implementing a medical records registration system in accordance with one embodiment of the present invention;

FIG. 4 is a diagram illustrating an electronic band using USB communication protocol used as a portable medical device in accordance with one embodiment of the present invention;

FIG. 5 is a diagram illustrating an alternative example of electronic storage in a necklace form used as a portable medical device in accordance with one embodiment of the present invention;

FIG. 6 illustrates another example of electronic storage in a necklace form used as a portable medical device in accordance with one embodiment of the present invention;

FIG. 7 illustrates a watch having a watch band with a USB connector used as a portable medical device in accordance with one embodiment of the present invention;

FIG. 8 illustrates a keychain having a USB attachment used as a portable medical device in accordance with one embodiment of the present invention;

FIG. 9 is a block diagram illustrating storage devices structured in credit card form used as a portable medical device in accordance with one embodiment of the present invention;

FIG. 10 is a diagram illustrating an electronic name tag using USB communication protocol used as a portable medical device in accordance with one embodiment of the present invention;

FIG. 11 illustrates examples of USB electronic name tags used as a portable medical device in accordance with one embodiment of the present invention;

FIG. 12 is a watch having a USB attachment used as a portable medical device in accordance with one embodiment of the present invention;

FIG. 13 is a block diagram illustrating a portable device capable of storing medical information protected by an authentication mechanism in accordance with one embodiment of the present invention;

FIG. 14 is a block diagram illustrating a digital processing system capable of managing medical records communications in accordance with one embodiment of the present invention; and

FIG. 15 is a diagram illustrating a computer network capable of communicating with the medical records registration system in accordance with one embodiment of the present invention.

### DETAILED DESCRIPTION

Embodiments of the present invention are described herein in the context of a method, system and apparatus for controlled transfer of individual's medical information.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application- and business-related constraints, and that these specific goals will vary from one implementation to another and from one developer to another. It, however, will be understood that such a development effort might be complex and time-consuming, but would nevertheless be a routine undertaking of engineering for those of ordinary skills in the art having the benefit of embodiment(s) of this disclosure.

Various embodiments of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method.

Unless otherwise defined, all terms (including technical and scientific terms) used herein have the same meaning as commonly understood by one of ordinary skills in the art to which the exemplary embodiment(s) belongs. It will be further understood that terms, such as those defined in commonly used dictionaries, should be interpreted as having a meaning that is consistent with their meaning in the context of the relevant art and this exemplary embodiment(s) of the disclosure unless otherwise defined.

As used herein, the singular forms of article “a”, “an” and “the” are intended to include the plural forms as well, unless the context clearly indicates otherwise. Also, the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items

A network, in one embodiment, includes a portable medical device and a medical records registration (“MRR”) system for handling and transferring medical information. The portable medical device includes patient or client verification information and it is capable of issuing a request for medical related information via a communications network. The MRR system is capable of authenticating the request in response to a set of predefined verifications and obtaining the medical related information after passage of the authentication. The medical related information is subsequently forwarded in accordance with the request.

It should be noted that the term a patient can also be referred to as a “client,” “user,” “people,” “person,” and the like. In addition, the term “portable medical device” can also be referenced to as “mobile phone,” “laptop,” “memory card,” “memory stick,” or the like that can be configured to be portable medical devices.

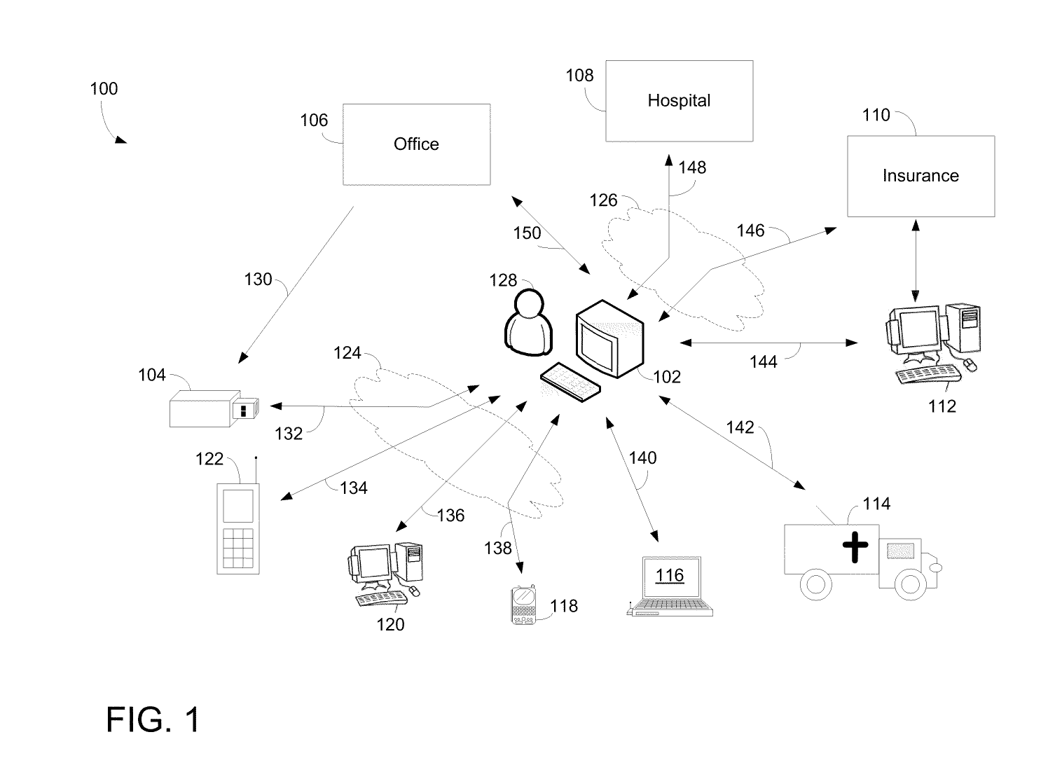

FIG. 1 is a block diagram 100 illustrating a network having a medical records registration system in accordance with one embodiment of the present invention. Diagram 100 includes a MRR system 102, a doctor's office 106, a hospital 108, an insurance company 110, a server 112, and several portable devices. MRR system 102, in one embodiment, is managed and monitored by one or more administrators 128. It should be noted that the underlying concept of the exemplary embodiment(s) of the present invention would not change if one or more blocks (devices or systems) were added to or removed from diagram 100.

In one embodiment, a portable medical device 104, a mobile cellular phone 122, a personal computer (“PC”) 120, and a smart phone (or personal digital assistance) 118 are logically coupled to MRR system 102 via a communications network 124 through connections 132-138. Note that cellular phone 122, PC 120, and smart phone 118 can be portable medical devices capable of facilitate medical file transfer between MRR system 102 and specified devices such as portable device 104, phone 122 and/or PDA 118. Network 124 can be the Internet and/or other networks including wireless communications network. Connections 132-138 can be any electrical circuits, cables, wires, and/or wireless channels capable of transferring data.

Office 106, in one example, can be a local medical group that having a relatively small database used for storing its patients' medical records. Although the medical records are electronically stored, they are normally prevented from forwarded to outside of the clinic or office 106 via electronic format. Hospital 108, on the other hand, includes larger local and/or remote storage servers capable of storing larger amount of patients' medical records. In some instances, the storage servers store medical records for all of its affiliated medical institutions. Hospital 108, however, usually does not transfer its medical records or files electronically to outside individuals or other institutions.

Insurance company 110 includes a database configured to store relevant medical records for all of its clients including, but not limited to, medical insurance subscribers as well as life insurance subscribers. Medical server 112, which can be a server farms used by government institutions, contains massive amount of medical records for health statistics. It should be noted that the medical records stored in office 106, hospital 108, insurance 110, and medical server 112 generally do not share with each other.

Referring back to FIG. 1, office 106, hospital 108, insurance 110, and server 112 are coupled to MRR system 102 via connections or channels 144-150 wherein hospital 108 and insurance 110 use a communications network 126 to reach MRR system 102. It should be noted that network 124 and 126 can be the same network or a combination of multiple networks. An ambulance 114 and laptop computer 116 are capable of communicating with MRR system 102 via one or multiple wireless communications networks.

The network as illustrated by diagram 100 includes a portable medical device such as device 104 and a MRR system 102. Device 104, in one embodiment, includes patient verification information and is capable of issuing a request for a transfer of medical related information via a communications network such as network 124. MRR system 102, which is logically coupled to the portable medical device, is capable of authenticating the request issued by device 104 in response to a set of predefined verifications. After obtaining the medical related information after process of the authentication, the medical related information is forwarded in accordance with the request. In one example, MRR system 102 is capable of instructing a remote medical server located at a medical institution such as office 106 to forward at least a portion of the medical related information directly to portable medical device 104 via a channel 130.

MRR system 102, in one embodiment, is a control hub capable of facilitating medical records transfer electronically upon authentication of the request or user or patient. To facilitate medical file transfer, every user including an individual as well as an institution is required to register with MRR system 102. During the process of registration, each user submits his or her medical profile such as current medication(s) and health conditions. Health conditions include diabetes, high blood pressure, and the like. The hospitals or clinics are also required to register and identified natures of the institutions and services. Once MRR system 102 establishes an authentication database, it is ready to facilitate online medical file transfer. The authentication database is also known as a database contains a set of predefined information, such as a unique MRR number and level of services.

Depending on the applications, MRR system 102 can provide one or multiple levels of services in accordance with the original authentication data as well as the request initiated by the portable medical device. For example, during the registration phase, the patient can specifically authorize MRR system 102 to provide his/her entire medical records to hospital 108 upon receipt of a request initiated by portable device 104. Alternatively, if the portable device 104 requests a transfer to itself, MRR system 102 automatically transfer a predefined portion of the medical records. For example, MRR system 102 only transfers medical related information such as current health condition and medication instead of entire medical records. A benefit of transfer controlled medical information is instant highlights of holder's health condition, which can be especially helpful after an accident. For instance, when a paramedic from ambulance 114 tries to revive a patient, it is helpful to know what the patient's current health condition as well as medication(s) used.

In another embodiment, when a clinic's PC 120 request an online medical records transfer via a portable medical device plugged in at a USB port of PC 120, MRR system 102 is capable of authenticating both the clinic and the device. Upon verifying both clinic and portable medical device, MRR system 102 may authorize to transfer the entire medical records to clinic directly since clinic is usually a secure transfer.

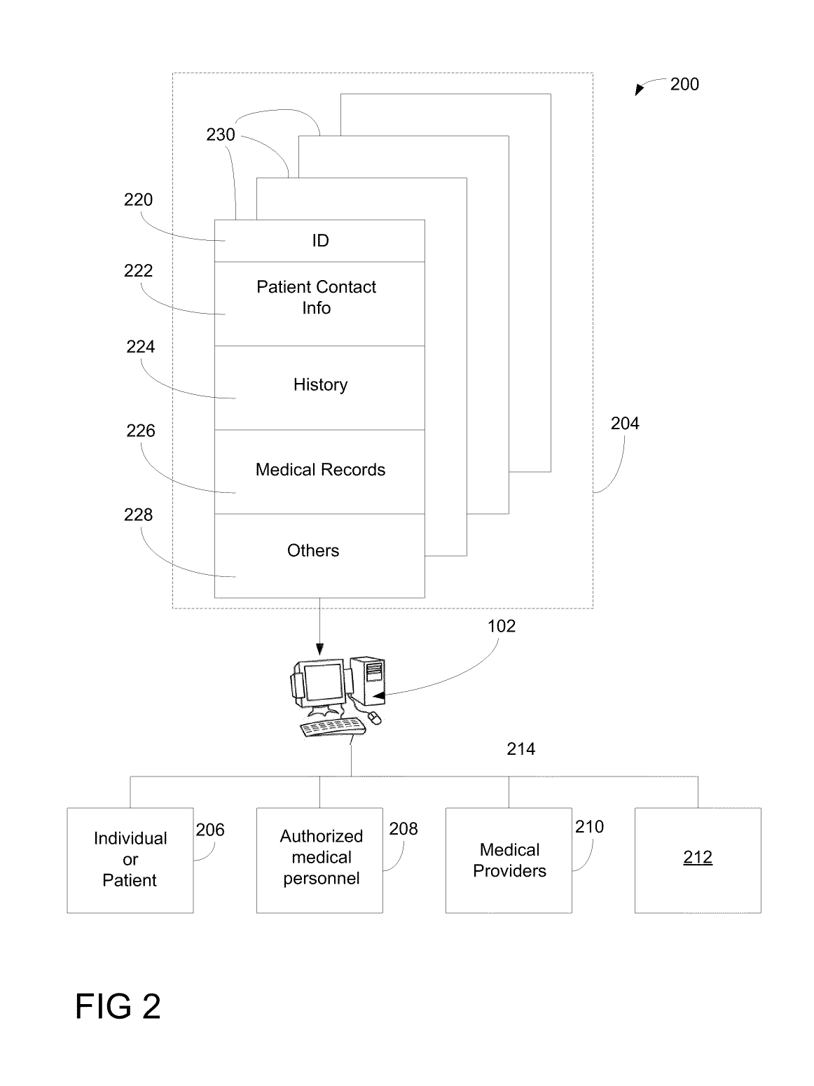

FIG. 2 is a block diagram 200 illustrating a medical records registration system in accordance with one embodiment of the present invention. System 200 includes a database 204, a computer system or MRR system 102, and clients 206-212. Clients 206-212, in one embodiment, include individuals, patients, authorized medical personnel, medical providers, and the like. It should be noted that the underlying concept of the exemplary embodiment(s) of the present invention would not change if one or more blocks (circuit or elements) were added to or removed from diagram 200.

Database 204 includes multiple storage locations 230 wherein each storage location 230 includes an ID section 220, an contact section 222, a history section 224, a medical records section 226, and others 228. To create a worldwide database 104 for medical/dental records, individuals can access such data through the web or Internet or World Wild Web. Each individual, for example, is assigned a record number 220 that can be accessed by medical professionals universally. Alternatively, a social security number may be used as a MRR number. Records can be accessed at the consent of the record holder.

All newly born babies, for example, can be registered and assigned with MRR numbers at time of birth. The system will also allow the user to transfer information to any medical care providers in a secure environment. Online medical records transfer or electronic medical records transfer can reduce the need for the user to make physical hard copies, and then mail or deliver the copies to a medical provider. It will also reduce the need for doctors to request medical records from other doctors. Instead, the clinic can access the patients file via the web based medical record registry via MRR system 102. This will enable records to be updated constantly and available for authorized access. In one embodiment, the medical record file is configured to contain three sections.

Patient contact information 122 or a section one (1) of 122 contains personal information such as a patient's contact information, individuals to contact information in event of emergency, medical insurance provider, in addition to important medical information in case of an emergency such as blood type, allergies, special conditions, etc.

History 224 or section two (2) includes notes entered by the record holder/guardian regarding user's health history or any other information in which various medical professionals may want to know. It will also include a calendar of routine checkups or physical examinations, historical information, family medical history, appointments, etc.

Medical records 226 or section three (3) contains permanent medical information entered by physicians 208 and/or licensed healthcare providers 210. This information may not be altered. New information can be added to this file but existing information cannot be removed. Existing information acts as READ files. It should be noted that it does not alter the concept of the embodiment of the present invention if additional sections are added to or removed from the medical record file.

When a baby is newly born, hospital staff, for example, may access the web based registry and enter all pertinent information regarding the newly born baby and obtain an MRR number. The system will generate a temporary username and password for a first time user. Whenever convenient, parent/guardian 206 will access the registry and create their username/password. Once users have successfully logged in, they will enter the MRR number to retrieve the individual's records. Parents/legal guardians can also create records anytime for their dependents. All adults over 18, for instance, may create a record for themselves.

In one embodiment, official medical information can be entered by physicians or licensed health care providers directly using a patient's MRR. Physician(s), however, may not access the records without account holders' consent. In an alternative embodiment, a patient can download his or her personal medical records from the system to a portable device and provide the portable device to his or her physician(s). It should be noted that the download can occur at the physician's office.

When a physician 210 logs into the registry and after credentials are approved, a physician 210 can load information to the database using the patients MRR number. The system's software will compartmentalize the information under the proper medical directory of the patient's records. The system will independently email the physician a confirmation message indicating that medical information sent by the doctor's office has been added to a patient's records. Another email will advise the account user that medical information has been added to their file. It should be noted that an encryption system may be used to secure the communication between patients and hospitals, hospitals and medical groups, doctors and patients, and the like.

Individuals may request to have unrecorded medical data loaded by licensed health care providers directly into the system. This automatically gets loaded under section three listed above. Any information loaded by the user can only go into category 1 or 2. The registry's software will store records in a medically recognized format, and will allow users to look at information based on the specialist's need, i.e. An orthopedist may choose to mostly access X-rays, whereby a dermatologist may be more interested in patients' skin conditions. A general practitioner may want to look at everything, etc.

The system will either be completely web based or web based interacting with a medical/dental records software (proprietary software) made available by the patent holder. The records may also be loaded and transferred wirelessly via secure channels. In one embodiment, the system employs authentication software, which complies with one or more governmental regulatory requirements, for transferring the medical records. For example, the system complies with the regulatory requirement of Health Insurance Portability Accountability Act (“HIPAA”) when the medical records are transferred within the United States. Alternatively, if the medical records are transferred between multiple countries, one or more regulatory requirements are complied with and implemented in order to transfer the medical records successfully and safely.

Note that MRR system 102 facilitates transfers of electronic medical records (“EMR”) between doctors and/or medical providers and patients. An advantage of using the MRR system is portability and transportability of records. For example, a patient is able to access his or her EMR and transport EMR at will to any healthcare provider. For instance, when a patient visits a new doctor, he or she can have his or her medical information delivered to the doctor while he or she is in the doctor's office via one of several methods. The doctor's office can login to the MRR system or MRR website and enter certain credentials provided by the patient to access the records on one time basis. Alternatively, the patient can be carrying the records on him electronically in a storage device or on his cell phone, et cetera. In yet another example, when the patient has an accident, rescue and emergency teams will be able to access, at least to a certain preset level, the patients info from an electronic storage device carried or worn by the patient.

The exemplary aspect of the present invention includes various processing steps, which will be described below. The steps of the aspect may be embodied in machine or computer executable instructions. The instructions can be used to cause a general purpose or special purpose system, which is programmed with the instructions, to perform the steps of the exemplary aspect of the present invention. Alternatively, the steps of the exemplary aspect of the present invention may be performed by specific hardware components that contain hard-wired logic for performing the steps, or by any combination of programmed computer components and custom hardware components.

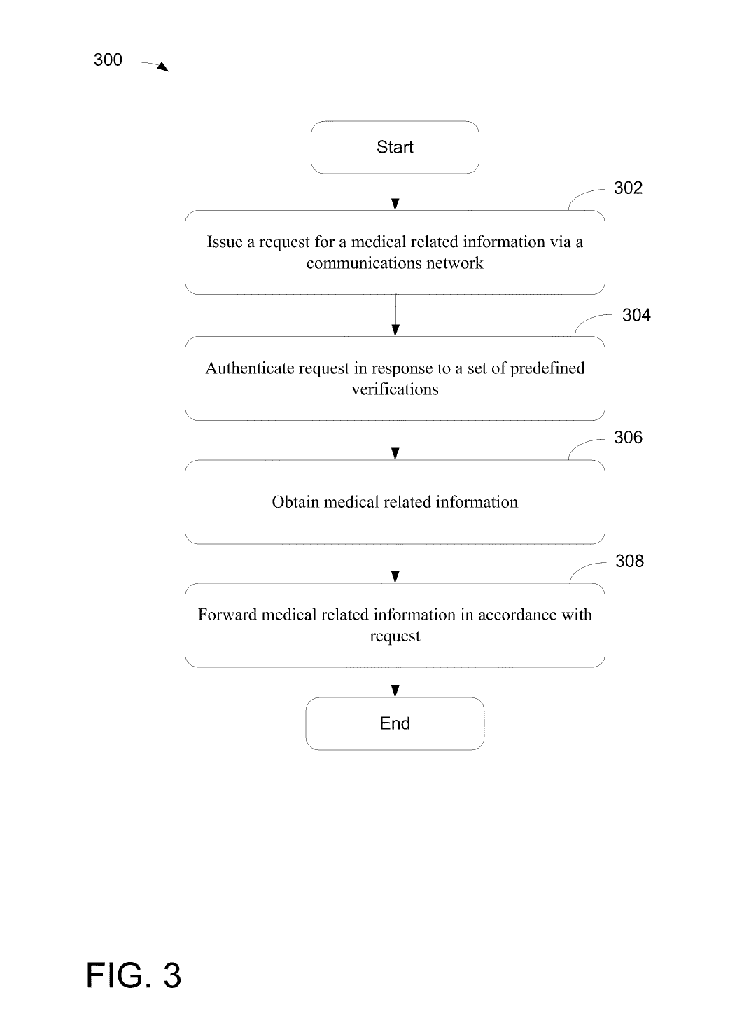

FIG. 3 is a flowchart 300 illustrating a process of implementing a medical records registration system in accordance with one embodiment of the present invention. At block 302, a process of EMR transfer issues a first request for first medical related information via a communications network such as the Internet. Upon initiating a request for transferring medical records from a portable medical device, the process is capable of sending the first request to a remote MRR system in accordance with information stored in a first portable medical device.

At block 304, the process authenticates the first request in response to a set of predefined verifications. In one embodiment, upon directing the first request to a MRR system, the process retrieves the first verification data from a local storage in response to information in the first request and authenticates the first request in response to the first verification data.

At block 306, the process obtains the first medical related information after authentication. The process in one embodiment retrieves the first medical related information from a remote server for a medical institution. Alternatively, the first medical related information can be retrieved from a local database coupled to a medical records registration system.

At block 308, the process forwards the first medical related information in accordance with the first request. In one embodiment, the process is capable of registering the first medical related information associated to a first person with a MRR system. The MRR system is allowed to distribute the first medial related information between a medical institution and the first person. It should be noted that the first medical related information is sent to a device specified by the first request. Alternatively, the first medical related information is sent to a predefined registered device specified by the first request. Also, the first medical related information is sent to a portable medical device specified by the first request. Upon issuing a second request for second medical related information via the communications network, the process authenticates the second request in response to a set of second predefined verifications and obtaining the second medical related information after authentication. The second medical related information is forwarded in accordance with the second request.

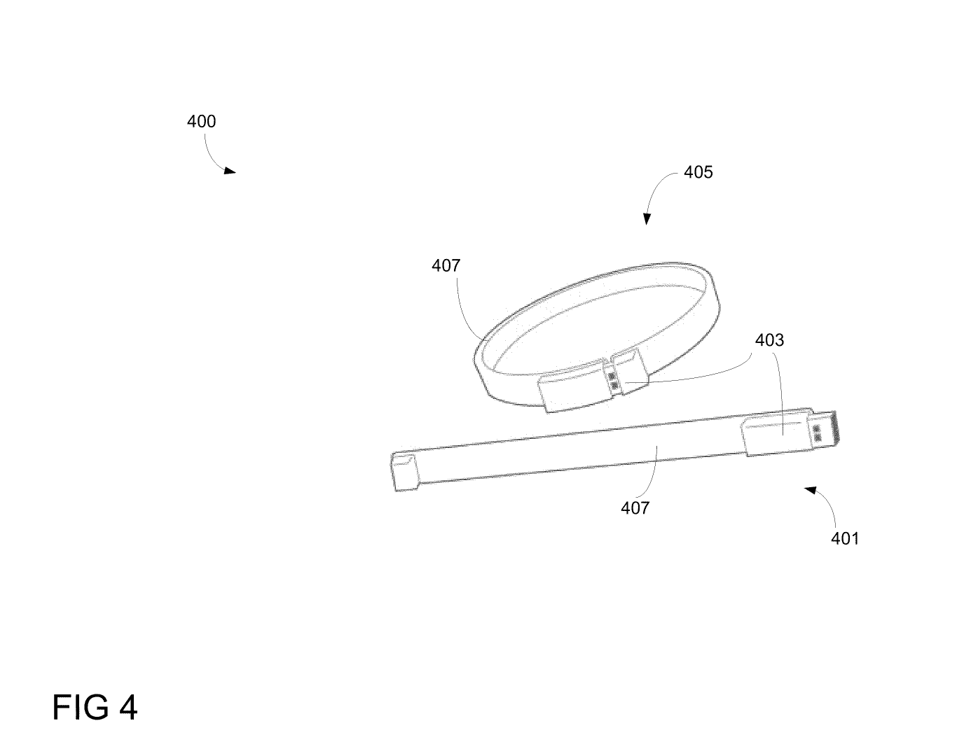

FIG. 4 is a diagram 400 illustrating an electronic band using USB communication protocol used as a portable medical device in accordance with one embodiment of the present invention. Diagram 400 illustrates an electronic band 101 having a storage unit 403. In one embodiment, storage unit 403 includes Universal Serial Bus (“USB”) connector and a flash memory for storing information. Unit 403 can be read and/or written via a USB protocol through a host not shown. Diagram 400 further illustrates another electronic band 405, which is similar to band 401 except that two ends of band 405 are connected by a USB fastening mechanism. It should be noted that the underlying concept of the exemplary embodiment(s) of the present invention would not change if one or more blocks (circuit or elements) were added to or removed from diagram 400. In one embodiment, storage unit 403 is used to store medical information.

It should be noted that USB is a serial bus standard to interface various devices using a standardized interface socket. USB devices allow hot swapping, which allows devices to be connected and/or disconnected without rebooting the system(s) or host(s). Flash memory, on the other hand, is non-volatile memory, wherein the medical information stored in the memory can be electrically programmed and/or erased. It should be further noted that technologies involved in non-volatile memory can be select gate process, split gate process, or EEPROM (Electrically Erasable Programmable Read-Only Memory).

The following features can be performed using a portable memory device capable of attaching to an object, such as a person, for storing information.
a. USB based, or a magnetic stripe based, and/or wireless based wrist band to be used for electronic storage, downloading, and transfer of medical records and information.
b. USB based, or a magnetic stripe based, and/or wireless based necklace or necklace hook to be used for electronic storage, downloading, and transfer of medical records and information.
c. USB based, or a magnetic stripe based, and/or wireless pendent to be used for electronic storage, downloading, and transfer of medical records and information.
d. USB based, or a magnetic stripe based, and/or wireless based identification tag/dog tag to be used for electronic storage, downloading, and transfer of medical records and information.
e. USB based, or a magnetic stripe based, and/or wireless based key chain to be used for electronic storage, downloading, and transfer of medical records and information.
f. USB based, or a magnetic stripe based, and/or wireless based credit card size wallet card to be used for electronic storage, downloading, and transfer of medical records and information.
g. USB based, or a magnetic stripe based, and/or wireless based watch band to be used for electronic storage, downloading, and transfer of medical records and information.
h. USB watchband attachment, or a magnetic stripe based, and/or wireless based watch band to be used for electronic storage, downloading, and transfer of medical records and information.
   (a.) through (h.) are hereinafter referred to as “Item”. In one embodiment, Item will be used in conjunction with medical records software (“MRS”). The medical records software (“MRS”) is accessed by the user to update, add, manage, and transfer medical records and information (“MR”). The MR is downloaded via a USB port or through a wireless connection or through a magnetic stripe into the “Item”. The MRS will be made available to healthcare providers and consumers.

Alternatively, the MRS may also be accessed through a website that will act as a data storage vault for MRS and the “Item” users. The website will also provide medical information for users. It should be noted that the information stored in the USB devices may include personal history, preferences, habits, financial records, and the like.

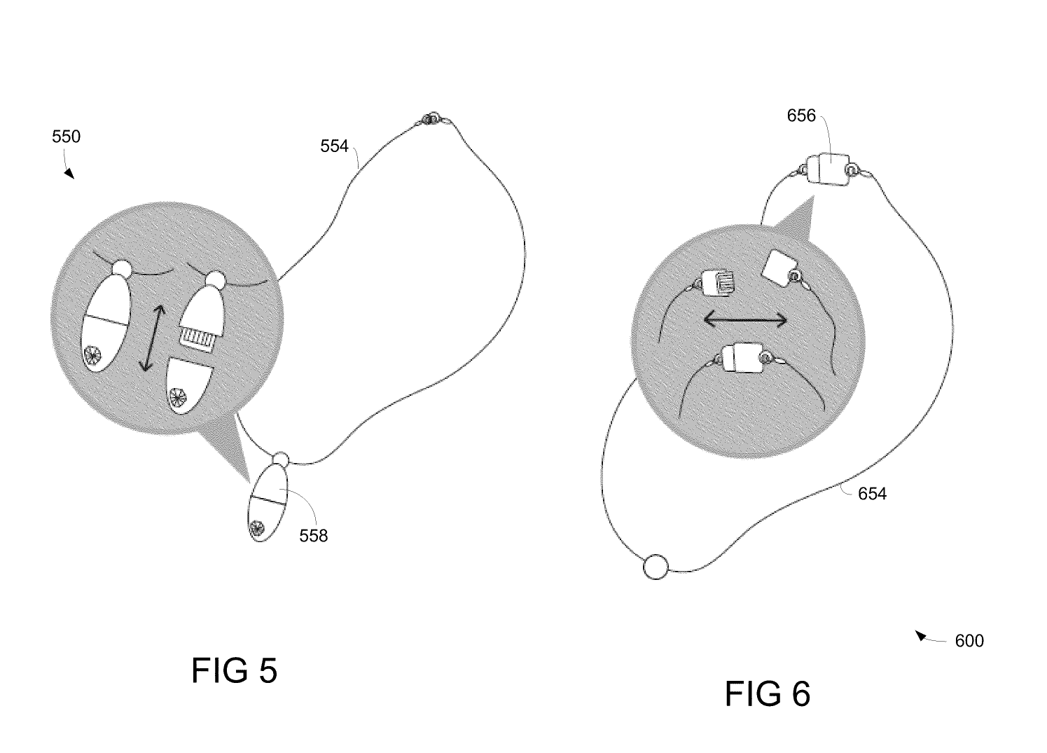

FIGS. 5-6 are diagrams 550 and 600 illustrating alternative examples of electronic storage in a necklace form used as a portable medical device in accordance with one embodiment of the present invention. Diagram 550 illustrates an electronic identification tag band and an electronic necklace band. Tag band includes a pendent 558 or 656, which include storage memories capable of remembering information such as medical records. In one embodiment, storage memory is used to keep medical records of the person who carries the storage device. Alternatively, the storage memory can be embedded in the tag band. Necklace band also includes a pendent 656, which is used to store information. Alternatively, pendent 558 may be used to communicate with other devices using wireless communication networks, such as Bluetooth technologies. It should be noted that the underlying concept of the exemplary embodiment(s) of the present invention would not change if one or more blocks (circuit or elements) were added to or removed from diagram 550 or 600.

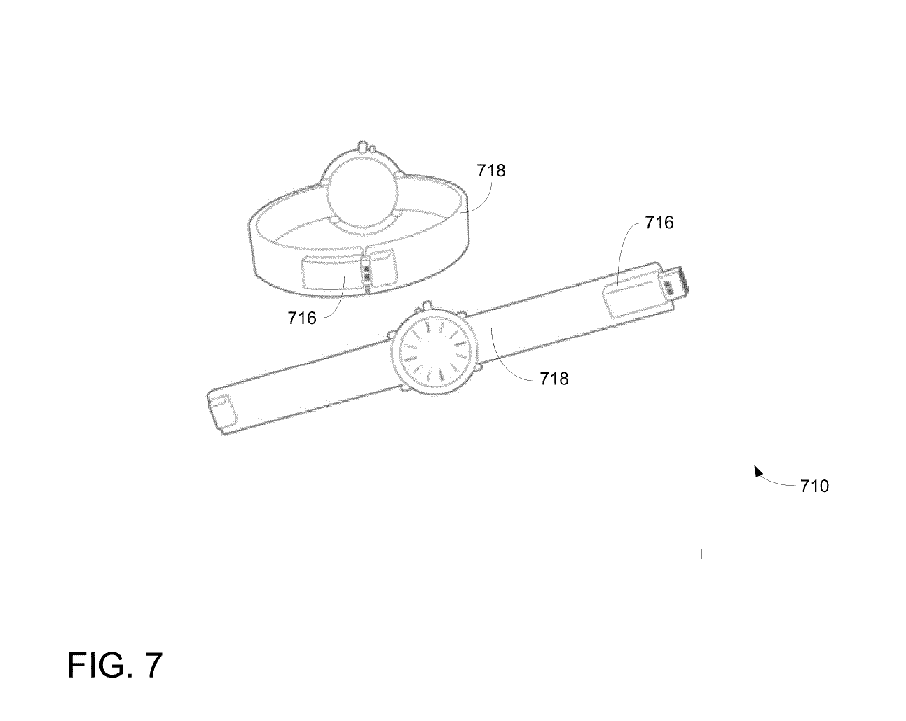

FIG. 7 is a block diagram 710 illustrating a watch with a watch band with a USB connector used as a portable medical device in accordance with one embodiment of the present invention. Diagram 710 illustrates a watchband having a USB connector 716, which is capable of connecting the band 718 together. In one embodiment, the USB storage memory is used to keep medical records of the person who carries the storage device. The watch can be configured to be a portable medical device.

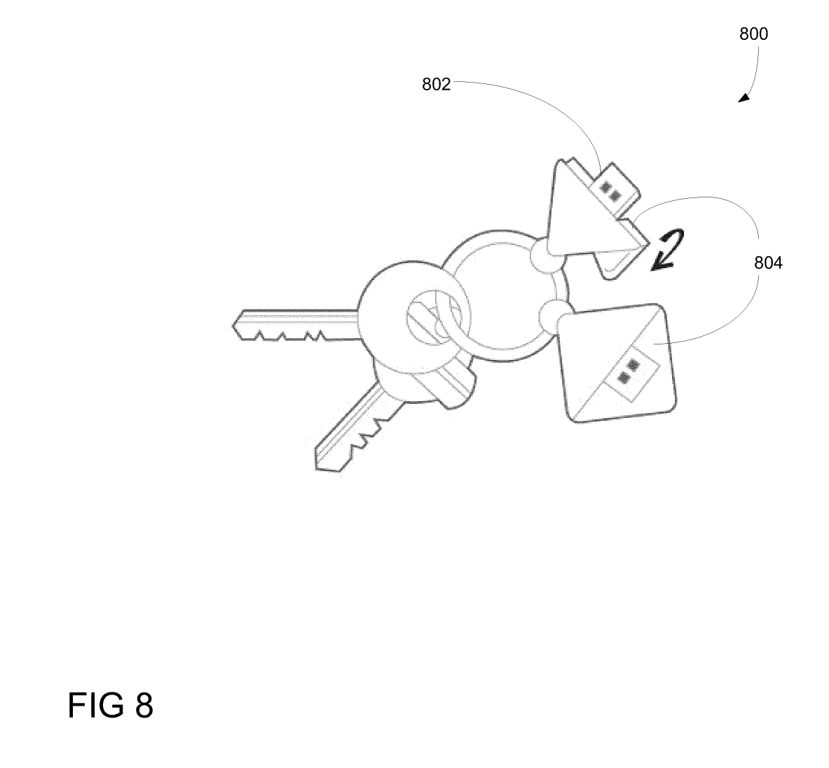

FIG. 8 illustrates a keychain 800 having a USB attachment 802 used as a portable medical device in accordance with one embodiment of the present invention. Keychain 502 further includes a cover 504, which provides protection of the USB storage memory. In one embodiment, storage memory is used to keep medical records of the person who carries the storage device. Keychain 800, in one embodiment, can be configured to be a portable medical device.

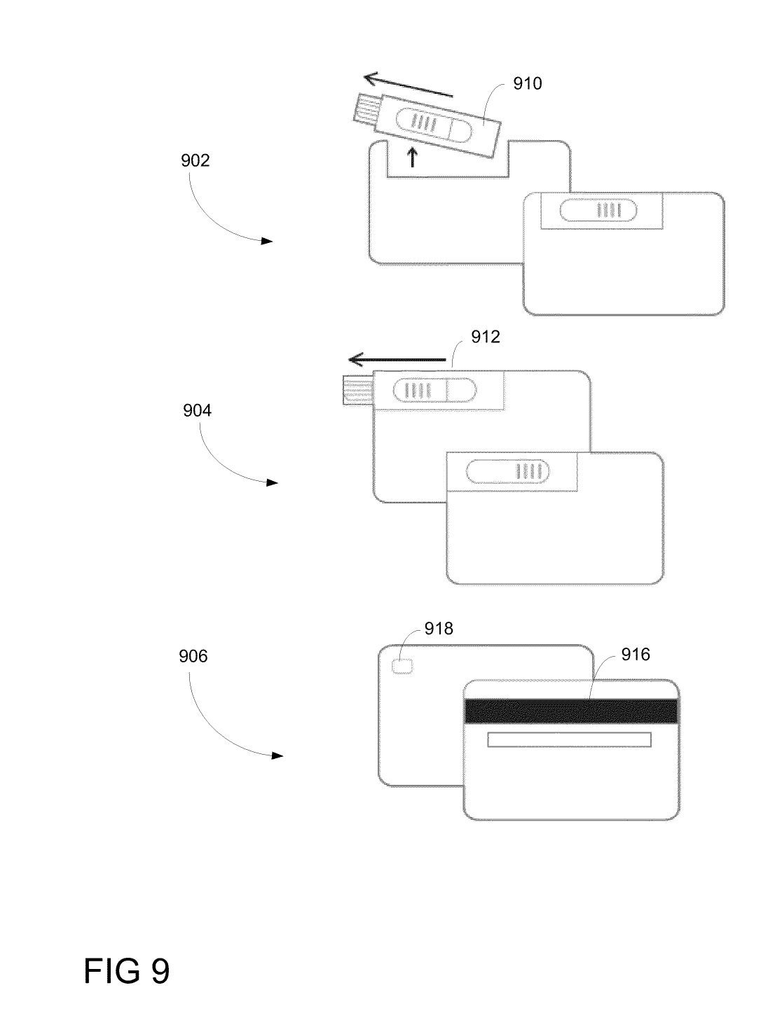

FIG. 9 is a block diagram illustrating storage devices 902-906 structured in credit card form used as a portable medical device in accordance with one embodiment of the present invention. In one embodiment, storage memory is used to keep medical records of the person who carries the storage device. Device 902 includes a USB memory device 910, which can be removed from the base card. Device 904 includes a USB memory device 912, which can not be removed from the card. Device 906 includes a magnetic stripe 914 or a smart chip 916 capable of storing medical information.

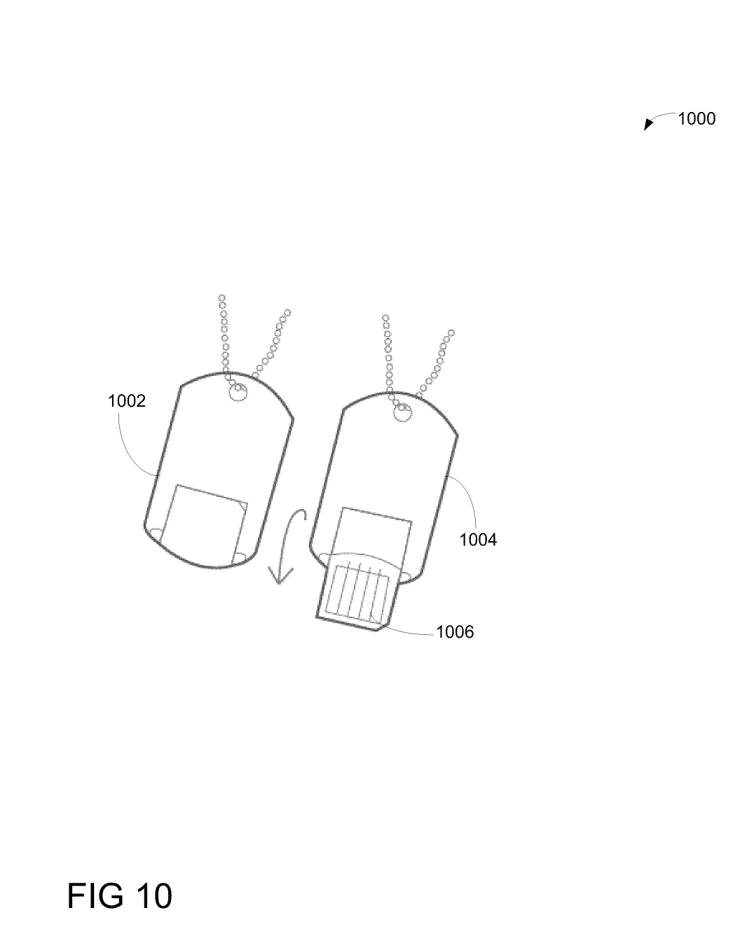

FIG. 10 is a diagram 1000 illustrating an electronic name tag using USB communication protocol used as a portable medical device in accordance with one embodiment of the present invention. Diagram 1000 illustrates electronic name tags 1002-1004 having storage units 1006. Name tags 1002-1004 can be used for soldiers, military personnel, government personnel, corporate employees, school students, and the like. Name tags 1002-1004 can also be used for animal applications, such as dog tags, cat tags, et cetera. In one embodiment, storage unit 1006 includes Universal Serial Bus (“USB”) connector and a flash memory for storing information. Unit 1006 can be read and/or written via a USB protocol through a host not shown in FIG. 1. Diagram 1000 also illustrates a movable connector, which can be used to connect to a USB connector of a host or a computer for data access. It should be noted that the underlying concept of the exemplary embodiment(s) of the present invention would not change if one or more blocks (circuit or elements) were added to or removed from diagram 1000. In one embodiment, storage unit 1003 is used to store information.

It should be noted that USB is a serial bus standard to interface various devices using a standardized interface socket. USB devices allow hot swapping, which allows devices to be connected and/or disconnected without rebooting the system(s) or host(s). Flash memory, on the other hand, is non-volatile memory, wherein the information stored in the memory can be electrically programmed and/or erased. It should be further noted that technologies involved in non-volatile memory can be select gate process, split gate process, or EEPROM (Electrically Erasable Programmable Read-Only Memory).

The following features can be performed using a name tag memory device capable of attaching to an object, such as a person or animal, for storing information.
a. USB based, or a magnetic stripe based, and/or wireless based name tag to be used for electronic storage, downloading, and transfer of information including wearer's personal vital information.
b. USB based, or a magnetic stripe based, and/or wireless based collar band name tag to be used for electronic storage, downloading, and transfer of information including wearer's personal vital information.
c. USB based, or a magnetic stripe based, and/or wireless based necklace name tag to be used for electronic storage, downloading, and transfer of information including wearer's personal vital information.
   (a.) through (c.) are hereinafter referred to as “Item”. In one embodiment, Item will be used in conjunction with name tag software (“NTS”). The NTS is capable of accessing the storage unit for updating, adding, managing, and transferring information such as personal, financial and/or records and information. The information is downloaded via a USB port or through a wireless connection or through a magnetic stripe into the “Item”. The NTS will be made available to dedicated or specified personnel and/or consumers.

In one embodiment, the tag is capable of storing medical information for the person who wears the tag. Alternatively, the tag can also be used to store contact information, or other important information. An authentication system may be used to secure from unauthorized access of information stored in the tag.

Alternatively, the NTS may also be accessed through a website that will act as a data storage vault for NTS and the “Item” users. The website will also provide information for users. It should be noted that the information stored in the USB devices may include personal history, preferences, habits, financial records, and the like.

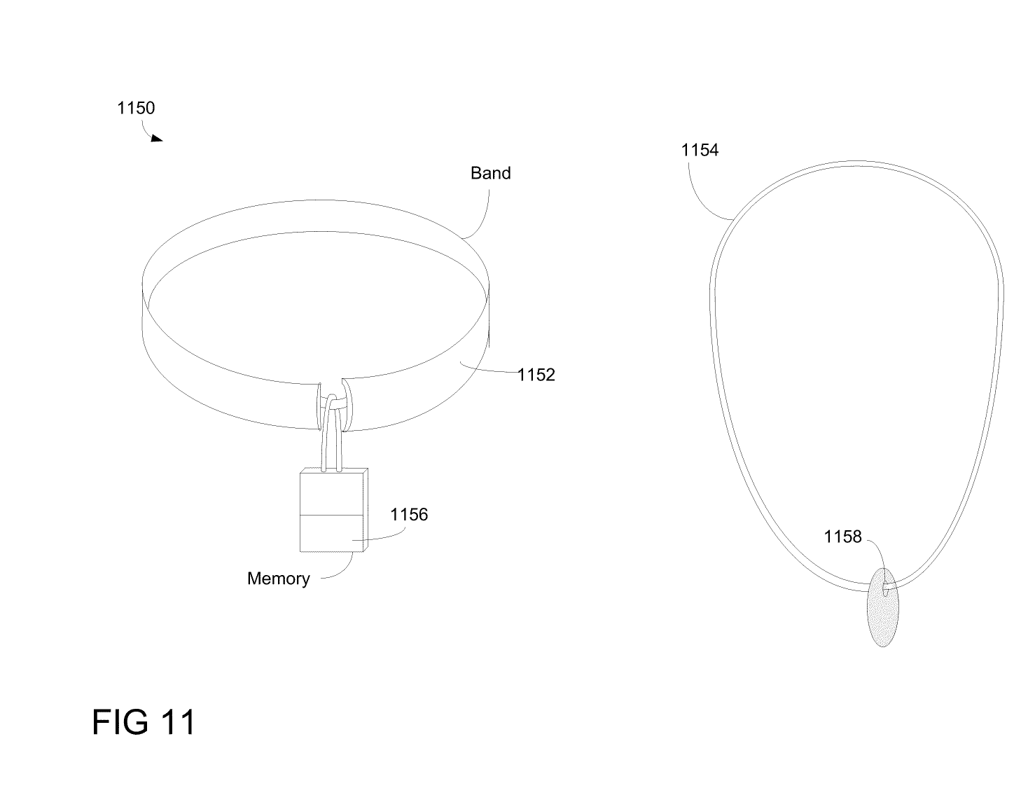

FIG. 11 is a diagram 1150 illustrating alternative exemplary electronic bands having storage capabilities in accordance with one embodiment of the present invention. Diagram 1150 illustrates an electronic identification tag band 1152 and an electronic necklace band. Tag band 1152 includes a pendent, which includes a storage memory capable of remembering information. In one embodiment, storage memory is used to keep private records of the person who carries the storage device. Alternatively, the storage memory can be embedded in the tag band 1152. Necklace band 1152 also includes a pendent 1156, which is used to store information. Alternatively, pendent 1158 may be used to communicate with other devices using wireless communication networks, such as Bluetooth technologies. It should be noted that the underlying concept of the exemplary embodiment(s) of the present invention would not change if one or more blocks (circuit or elements) were added to or removed from diagram 1150.

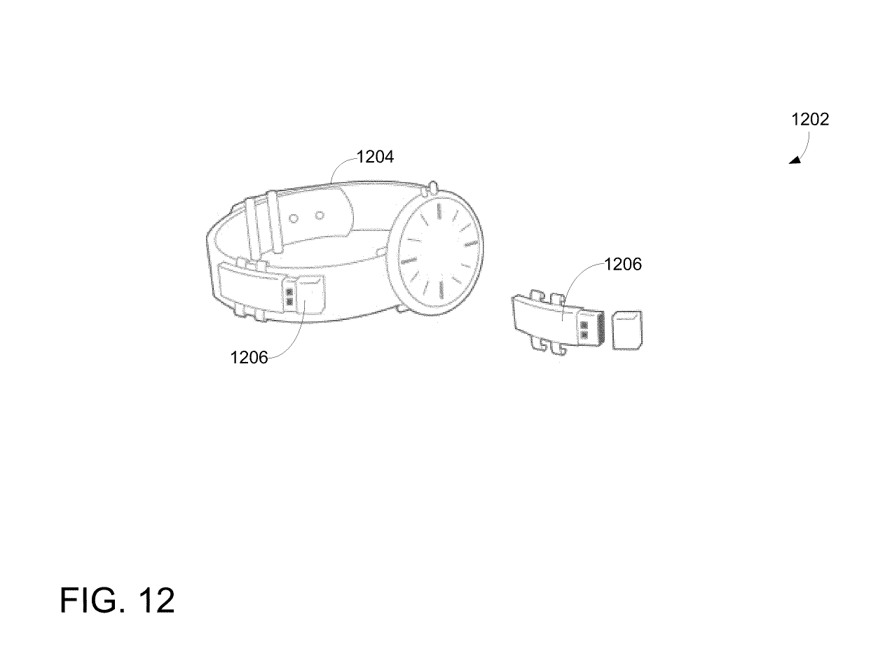

FIG. 12 is a watch 1202 having a USB attachment 1206 used as a portable medical device in accordance with one embodiment of the present invention. Diagram 1202 illustrates a USB attachment 1206 capable of fastening onto a watchband 1204. In one embodiment, storage memory is used to keep records of the person who carries the storage device. For example, the USB attachment can store medical information for the person who carries the attachment. An advantage of using the attachment is to mitigate or prevent the loss of the USB attachment since it attaches or anchors to another object, such as a watchband, wallet, glasses, and/or bag.

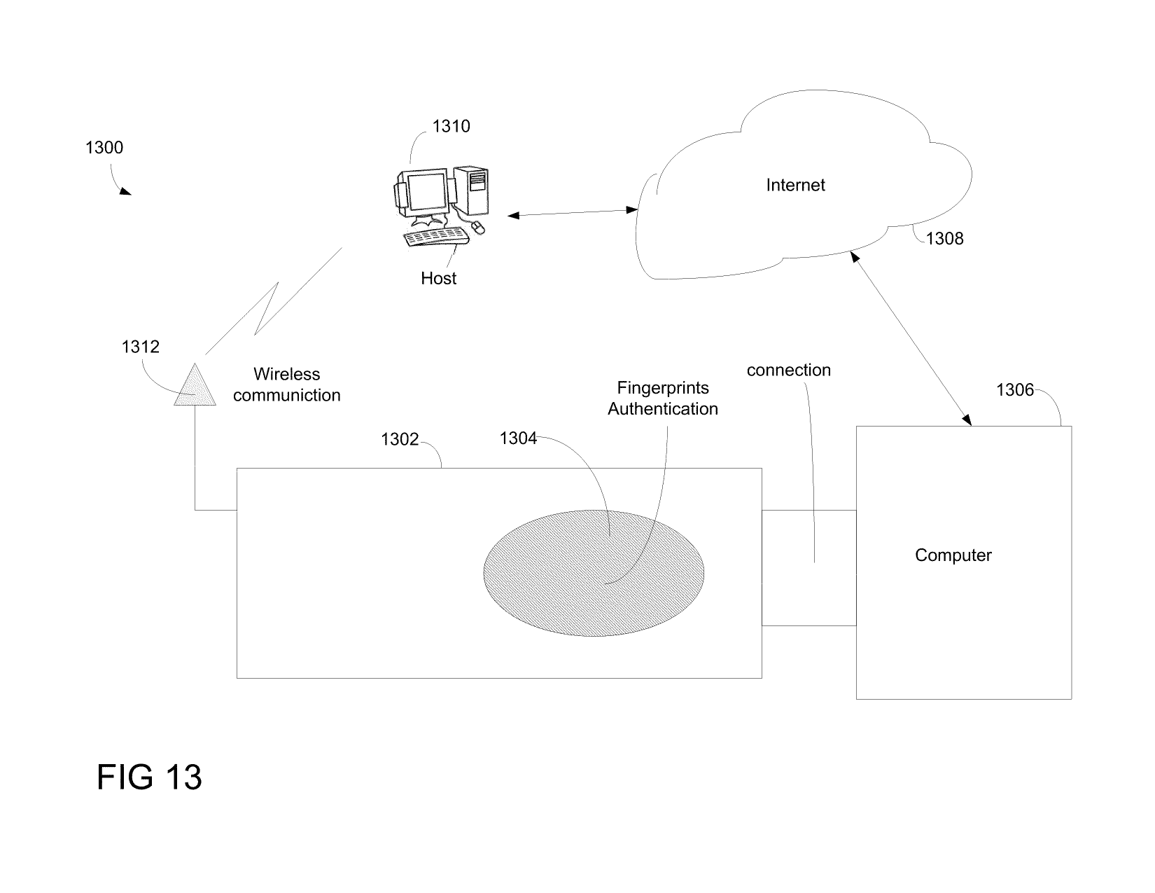

FIG. 13 is a block diagram 1300 illustrating a portable device capable of storing medical information protected by an authentication mechanism in accordance with one embodiment of the present invention. Diagram 1300 includes device 1302, a computer 1306, an Internet 1308, and a host 1310. Host 1310, in one embodiment, is capable of writing, reading, and updating the information stored in device 1302. It should be noted that depending the system configuration, computer 1306 can be the host instead of system 1310. It should be noted that the underlying concept of the exemplary embodiment(s) of the present invention would not change if one or more blocks (circuit or elements) were added to or removed from diagram 1300.

Device 1302, in one embodiment, includes authentication mechanism 1304 to secure unauthorized access. It should be noted that other types of authentication mechanisms may be used independently or together with the fingerprint authentication technique. Device 1302 also includes a wireless communication unit 1312, which may include multiple wireless radios with different communication capabilities such as 802.11* wireless LAN, cellular (GPRS, CDPD, 2.5G, 3G, etc), Bluetooth, Ultra-Wide Band (UWB), Zigbee, and other ad-hoc/mesh network technologies.

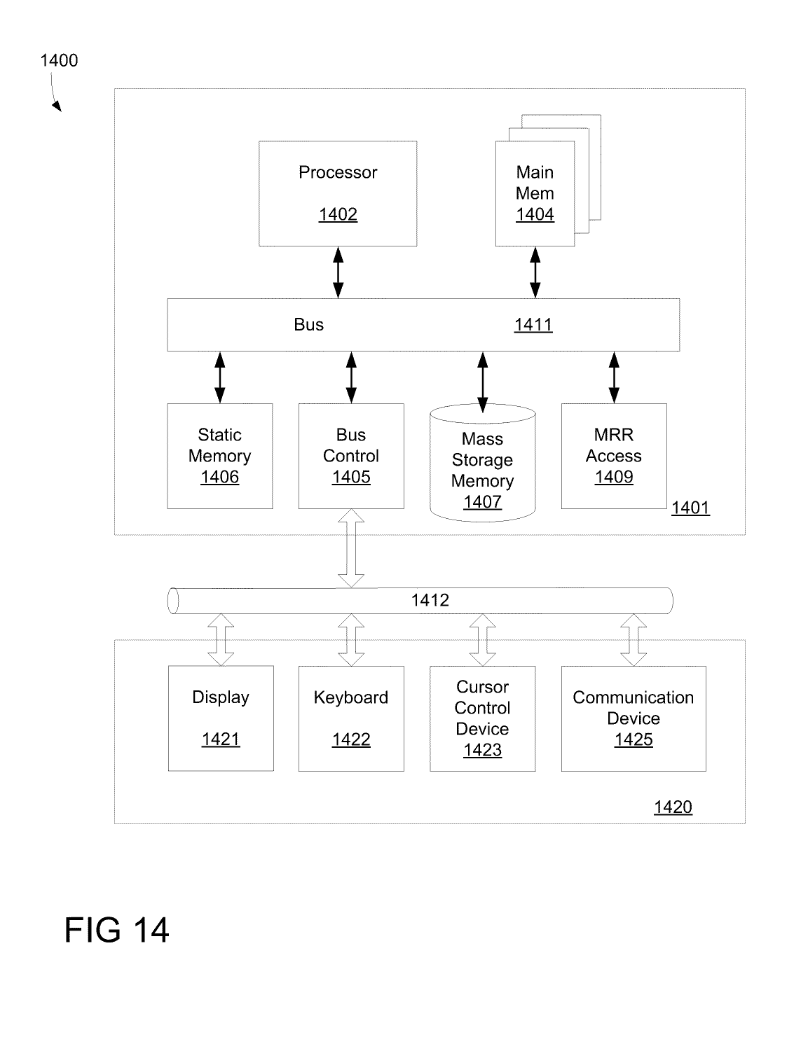

FIG. 14 is a block diagram illustrating a digital processing system capable of managing medical records communications in accordance with one embodiment of the present invention. Computer system 1400 includes a processing unit 1401, an interface bus 1411, and an input/output (“IO”) unit 1420. Processing unit 1401 includes a processor 1402, a main memory 1404, a system bus 1411, a static memory device 1406, a bus control unit 1405, a mass storage memory 1407, and a MRR access unit 1409. In one embodiment, unit 1409 is used to access and update individual medical records in response to a medical records registration. It should be noted that the underlying concept of the exemplary embodiment(s) of the present invention would not change if one or more blocks (circuit or elements) were added to or removed from diagram 1400.

Bus 1411 is used to transmit information between various components and processor 1402 for data processing. Processor 1402 may be any of a wide variety of general-purpose processors, embedded processors, or microprocessors such as ARM® embedded processors, Intel® Core™2 Duo, Core™2 Quad, Xeon®, Pentium™ microprocessor, Motorola™ 68040, AMD® family processors, or Power PC™ microprocessor.

Main memory 1404, which may include multiple levels of cache memories, stores frequently used data and instructions. Main memory 1404 may be RAM (random access memory), MRAM (magnetic RAM), or flash memory. Static memory 1406 may be a ROM (read-only memory), which is coupled to bus 1411, for storing static information and/or instructions. Bus control unit 1405 is coupled to buses 1411-1412 and controls which component, such as main memory 1404 or processor 1402, can use the bus. Bus control unit 1405 manages the communications between bus 1411 and bus 1412. Mass storage memory 1407, which may be a magnetic disk, an optical disk, hard disk drive, floppy disk, CD-ROM, and/or flash memories are used for storing large amounts of data.

I/O unit 1420, in one embodiment, includes a display 1421, keyboard 1422, cursor control device 1423, and communication device 1425. Display device 1421 may be a liquid crystal device, cathode ray tube (“CRT”), touch-screen display, or other suitable display device. Display 1421 projects or displays images of a graphical planning board. Keyboard 1422 may be a conventional alphanumeric input device for communicating information between computer system 1400 and computer operator(s). Another type of user input device is cursor control device 1423, such as a conventional mouse, touch mouse, trackball, or other type of cursor for communicating information between system 1400 and user(s).

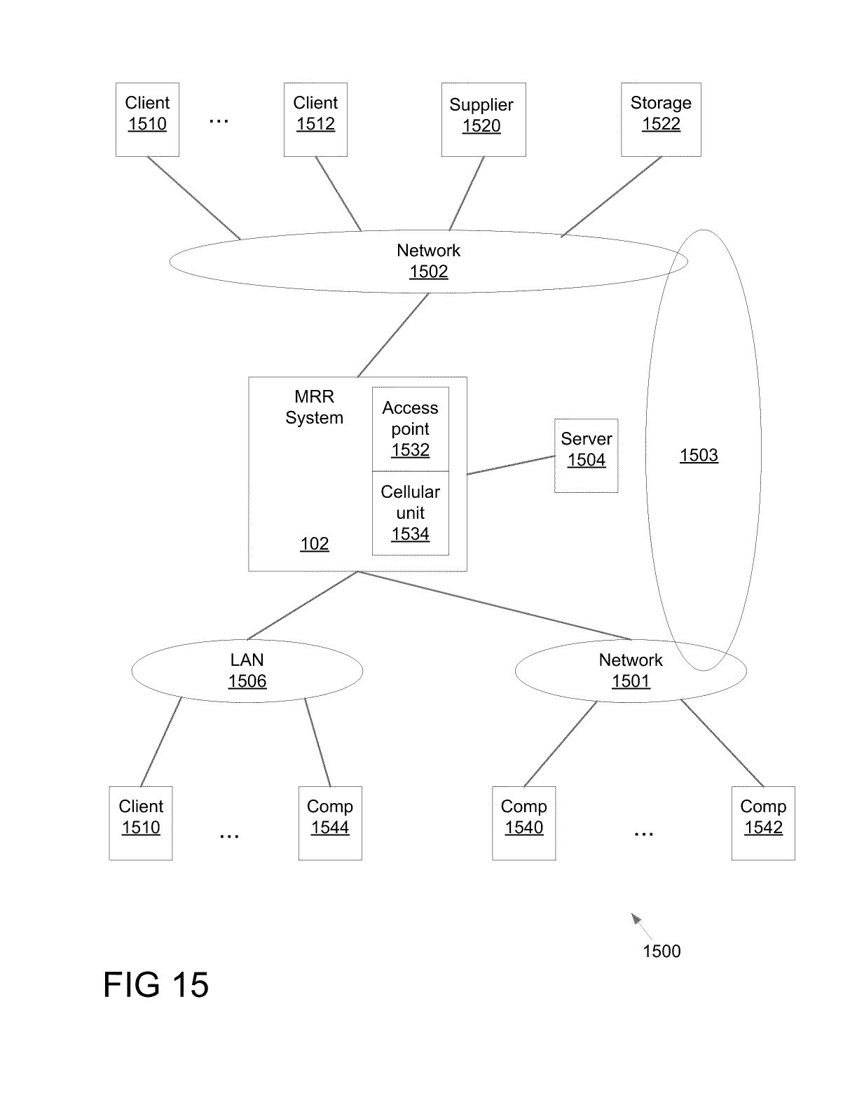

Communication device 1425 is coupled to bus 1411 for accessing information from remote computers or servers, such as server 104 or other computers, through wide-area network 102. Communication device 1425 may include a modem or a network interface device, or other similar devices that facilitate communication between computer 1400 and the network. Computer system 1400 may be coupled to a number of servers 104 via a network infrastructure such as the infrastructure illustrated in FIG. 15. Having briefly described one embodiment of the computer system in which the embodiment(s) of the present invention operates, FIG. 15 illustrates an example of a computer system 1400, which is a server 1504 or an exemplary client system 1510-1512 or a computer system.

FIG. 15 is a diagram 1515 illustrating a computer network capable of communicating with the medical records registration system in accordance with one embodiment of the present invention. FIG. 15 is a diagram illustrating a computer network 1500 capable of communicating with the medical records registration system in accordance with one embodiment of the present invention. Computer network topology 1500 illustrates a network environment in which the medical records registration system 1400 can be implemented in accordance with one embodiment of the present invention. In this network environment, electronic band 1501 can be coupled to a wide-area network 1502. Wide-area network 1502 includes the Internet, or other proprietary networks including America On-Line™, SBC™, Microsoft Network™, and Prodigy™. Wide-area network 1502 may further include network backbones, long-haul telephone lines, Internet service providers, various levels of network routers, and other means for routing data between computers.

Server 1504 is coupled to wide-area network 1502 and it is, in one aspect, used to route data to clients 1514-1516 through a local-area network (“LAN”) 1506. The LAN connection allows client systems 1514-1516 to communicate with each other through LAN 1506 and to communicate with planning system 1530 via LAN 1506 and server 1504. Using conventional network protocols, USB portable system 1530 may communicate through wide-area network 1502 to a plurality of client computer systems 1510-1512, supplier system 1520 and storage device 1522. For example, client system 1510 is connected directly to wide-area network 1502 through direct or dial-up telephone or other network transmission lines. Alternatively, clients 1510-1512 may be connected through wide-area network 1502 using a modem pool.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope all such changes and modifications as are within the true spirit and scope of the exemplary embodiment(s) of is present invention.

What is claimed is:

1. A method of accessing information, comprising:
issuing a first request for first medical related information via a communications network;
authenticating the first request in response to a set of predefined verifications;
obtaining the first medical related information after authentication; and
forwarding the first medical related information in accordance with the first request.

2. The method of claim 1, further comprising registering the first medical related information associated to a first person with a medical records registration (“MRR”) system.

3. The method of claim 2, wherein registering the first medical related information associated to a first person with a MRR system allowing the MRR system to distribute the first medial related information between a medical institution and the first person.

4. The method of claim 1, wherein issuing a first request for a first medical related information via a communications network includes initiating a request for transferring medical records from a portable medical device capable of communicating with the communications network.

5. The method of claim 4, wherein initiating a request for transferring medical records from a portable medical device capable of communicating with the communications network includes sending the first request to a remote medical records registration (“MRR”) system in accordance with information stored in a first portable medical device.

6. The method of claim 1, wherein authenticating the first request in response to a set of predefined verifications includes:
directing the first request to a medical records registration (“MRR”) system;
retrieving the first verification data from a local storage in response to information in the first request; and
authenticating the first request in response to the first verification data.

7. The method of claim 1, wherein obtaining the first medical related information after authentication further includes retrieving the first medical related information from a remote server for a medical institution.

8. The method of claim 1, wherein obtaining the first medical related information after authentication further includes retrieving the first medical related information from a local database coupled to a medical records registration system.

9. The method of claim 1, wherein forwarding the first medical related information in accordance with the first request includes sending the first medical related information to a device specified by the first request.

10. The method of claim 1, wherein forwarding the first medical related information in accordance with the first request includes sending the first medical related information to a predefined registered device specified by the first request.

11. The method of claim 1, wherein forwarding the first medical related information in accordance with the first request includes sending the first medical related information to a portable medical device specified by the first request.

12. The method of claim 1, further comprising:
issuing a second request for a second medical related information via the communications network;
authenticating the second request in response to a set of second predefined verifications;
obtaining the second medical related information after authentication; and
forwarding the second medical related information in accordance with the second request.

13. A method of managing medical information, comprising:
allocating a database having a plurality of individual records for storing medical related information;
designating a first portion of each individual record for storing patient contact information and authentication information;
designating a second portion of each individual record for storing patient history;
designating a third portion of each individual record for storing patient medical records; and
permitting a remote access to one of the first, second, and third portions by a registered patient for predefined data after authentication.

14. The method of claim 13, wherein allocating a database having a plurality of individual records for storing medical related information includes assigning a portion of memory in a medical records registration (“MRR”) system for storing the plurality of individual records.

15. The method of claim 13, wherein designating a first portion of each individual record for storing patient contact information and authentication information includes assigning a unique MRR number for each patient.

16. The method of claim 13, wherein designating a second portion of each individual record for storing patient history includes storing data relating to relevant medical professionals and medications in connection to a particular patient.

17. The method of claim 13, wherein designating a third portion of each individual record for storing patient medical records includes obtaining at least a portion of patient medical records from a remote predefined hospital.

18. The method of claim 13, wherein permitting a remote access to one of the first, second, and third portions further includes authenticating an access request from the registered patient via a communications network in accordance with the authentication information.

19. A network for transferring medical information, comprising:
a portable medical device having patient verification information and capable of issuing a request for a medical related information via a communications network; and
a medical records registration (“MRR”) system logically coupled to the portable medical device via the communications network, and configured to perform:
authenticating the request in response to a set of predefined verifications;
obtaining the medical related information after authentication; and
forwarding the medical related information in accordance with the request.

20. The network of claim 19, wherein the MRR system is further capable of instructing a remote medical server located at a medical institution to forward at least a portion of the medical related information in response to the request.
